(19) United States
(12) Patent Application Publication
(10) Pub. No.: US 2012/0142963 A1
(43) Pub. Date: Jun. 7, 2012

(54) PROCESS FOR PRODUCING COCOA HUSK EXTRACT

(76) Inventor: Michael William Pleasants, Sharnbrook (GB)

(21) Appl. No.: 13/388,381

(22) PCT Filed: Jul. 12, 2010
(86) PCT No.: PCT/EP2010/059961

§ 371 Date: Feb. 14, 2012

(30) Foreign Application Priority Data
Aug. 7, 2009 (EP) 09167439.0

(51) Int. Cl. C07C 229/08; C07C 227/40

(52) U.S. Cl. 562/554; 562/553

(57) ABSTRACT

A process for producing a cocoa husk extract containing gamma-aminobutyric acid (GABA) is provided, the process comprising: a) extracting GABA and methylxanthines from cocoa husks with an aqueous medium thereby to form an aqueous solution containing GABA and methylxanthines; b) removing at least part of the methylxanthines from the aqueous solution with a solvent which is immiscible with water; and c) retaining the aqueous solution containing the GABA. A cocoa husk extract comprising GABA and methylxanthines wherein the ratio of GABA to methylxanthines is at least 1:20 and a food product containing such an extract are also provided.

### TECHNICAL FIELD OF THE INVENTION

The present invention relates to a process for producing a cocoa husk extract, in particular it relates to a process for producing a cocoa husk extract that contains high levels of gamma-aminobutyric acid.

### BACKGROUND TO THE INVENTION

Chocolate and chocolate products are believed to be mood enhancing. Part of the reason may be the pleasant taste that can help to make consumers feel happy. Additionally, chocolate contains substances that, when consumed in sufficient quantity, are psycho-pharmacologically active (Smit et al., Psychopharmacology 2004, 176, pp 412-419). These substances include gamma-aminobutyric acid (GABA). GABA is the predominant neurotransmitter in the brain; it functions as an inhibitory neurotransmitter stopping the nerve impulse and is regarded as having relaxing/calming properties. Much interest surrounds GABA's ability to impart a calming effect, which can partially be demonstrated by its ability to reduce blood pressure.

It is appealing to consumers to eat chocolate to relax rather than, for example, to take prescription medicines. However, the level of GABA in chocolate is usually too low to have a substantial effect on mood states. Moreover, in addition to GABA, cocoa products also contain stimulatory mood actives, in particular methylxanthines including caffeine and theobromine which are believed to negate the potential relaxing/calming effects of GABA. JP 2005/348656 discloses a food or beverage, in particular chocolate or cocoa, having a relaxatory effect. The product contains elevated levels of GABA prepared by fermenting a culture liquid (consisting of sodium glutamate, glucose, yeast extract and emulsifier) with a lactic acid bacillus. However, in many countries there are strict rules concerning what ingredients are permissible in products which are labelled “chocolate”. Therefore the addition of GABA derived from sources other than theobroma cacao to chocolate products raises product nomenclature issues. Thus, there remains a need for chocolate products which have enhanced relaxatory effects, but which do not suffer from these problems.

### BRIEF DESCRIPTION OF THE INVENTION

We have now found that a cocoa extract containing elevated amounts of GABA can be produced by extracting GABA from cocoa husk. The extract can then be added to cocoa products and since the GABA is derived from theobroma cacao it is a “clean label” source and is consistent with regulatory rules for chocolate products.

Accordingly, in a first aspect, the present invention provides a process for producing a cocoa husk extract containing gamma-aminobutyric acid (GABA), the process comprising:
a) Extracting GABA and methylxanthines from cocoa husks with an aqueous medium thereby to form an aqueous solution containing GABA and methylxanthines; then
b) Removing at least part of the methylxanthines from the aqueous solution with a solvent which is immiscible with water; and then
c) Retaining the aqueous solution containing the GABA.

In a second aspect, the invention provides a cocoa husk extract comprising GABA and methylxanthines wherein the ratio of GABA to methylxanthines is at least 1:20.

In a third aspect, the invention provides a food product containing an extract according to the second aspect.

The invention also provides cocoa husk extracts obtained and obtainable by the process of the first aspect of the invention.

### DETAILED DESCRIPTION OF THE INVENTION

All percentages, unless otherwise stated, refer to the percentage by weight.

During cocoa production, ripe cocoa pods are cut open and the fleshy pulp-covered cocoa beans are removed and anaerobically fermented by either box or heap fermentation. After several days fermentation the pulp and other materials surrounding the cocoa beans wither to form a cocoa husk around the beans. In this specification the term “cocoa husk” is intended to include all materials surrounding the cocoa bean, including the pulp. The cocoa husk is separated from the beans (for example by roasting and winnowing), and the beans are then dried and packed ready for processing. Although cocoa husk has been found to be a source of a highly soluble dietary fibre, as disclosed in EP 1 886 578, cocoa husk is normally discarded at this stage in the cocoa production. It is a low value by-product typically used as an agricultural soil improver. However, we have now found that the cocoa husk is a source of natural GABA. In organisms, GABA is synthesized by the decarboxylation of L-glutamic acid catalysed by the enzyme glutamate decarboxylase. It is believed that the process of fermentation induces stress upon the cocoa beans and pulp which respond by synthesising increased levels of GABA. In addition, methylxanthines including theobromine and caffeine are also present in the cocoa husk.

We have developed a process for producing an extract with elevated levels of GABA from the cocoa husk. In the first step of the process, cocoa husks are brought into contact with an aqueous medium thereby to extract GABA from the husks into an aqueous solution. The contact between the aqueous medium and the husks causes soluble compounds within the husks to be extracted by the aqueous medium and an aqueous solution containing GABA and methylxanthines is therefore formed. In order to avoid the cocoa husks and aqueous medium forming an unprocessable gel the cocoa husks are preferably whole, as obtained directly from the winnowing step, or coarsely ground to a particle size of from 10 to 0.5 mm. The aqueous medium can be steam, water or an aqueous solution.

Where the aqueous medium is steam the temperature is greater than 100° C., preferably greater than 105° C., more preferably greater than 110° C. and preferably less than 150° C., more preferably less than 140° C. and more preferably still less than 130° C. Upon contacting the steam with the cocoa husks the steam condenses to form an aqueous solution containing GABA and also methylxanthines.

GABA is readily soluble in water and therefore the aqueous medium is preferably an aqueous solution, more preferably water and is preferably at a temperature of less than 90° C., more preferably less than 70° C., more preferably still less than 40° C., most preferably less than 30° C. Preferably the temperature of the aqueous solution is greater than 0° C., more preferably greater than 10° C. Methylxanthines are not very water-soluble at these temperatures and therefore only relatively low levels of methylxanthines will be extracted along with the GABA. The aqueous solution preferably has a pH of at most 9, more preferably at most 8 and preferably has a pH of at least 5, more preferably at least 6.

The cocoa husks are preferably in contact with the aqueous medium for at least 10 seconds, more preferably at least 20 seconds, more preferably still at least 30 seconds, most preferably at least 60 seconds. This extraction is a relatively rapid process and therefore the cocoa husks are preferably in contact with the aqueous medium for at most 60 minutes, more preferably at most 45 minutes and more preferably still at most 30 minutes.

The ratio of GABA to methylxanthines present in the aqueous cocoa husk extract is a function of the amount of the GABA and methylxanthines present in the cocoa husk and their relative solubilities. Even low levels of methylxanthines may cause stimulatory effects and therefore have the potential to counteract the relaxing/calming properties of GABA. Therefore a second process step is used to reduce the methylxanthine levels whilst retaining a high level of GABA. In this step a solvent which is immiscible with water and which has an affinity for methylxanthines (e.g. dichloromethane or ethyl acetate) is brought into contact with the aqueous solution. The methylxanthines readily dissolve in the immiscible solvent thereby removing at least part of the methylxanthines from the aqueous solution. The aqueous solution is then retained and forms the aqueous cocoa husk extract.

To ensure that the cocoa husks do not interfere with subsequent processing steps they may be removed from the aqueous solution using techniques known to the skilled person, e.g. by decanting the aqueous solution, and/or by pressing the cocoa husks to remove the aqueous solution, and/or through the use of filtration, and/or through the use of centrifugation.

The aqueous solution may also contain small particles of water-insoluble materials which are preferably removed using techniques such as filtration and/or centrifugation.

The aqueous solution may also contain high molecular weight compounds (i.e. greater than 150 g/mol), for example soluble fibres. These may be removed, for example by molecular weight extraction (also known as ultrafiltration).

The steps outlined above for the removal from the aqueous solution of cocoa husks, small particles of water-insoluble materials, and high molecular weight compounds may be carried out before or after the second step of the process and may be performed in any order, although it is preferable to remove the cocoa husk immediately after the aqueous extraction.

Finally, the aqueous cocoa husk extract is preferably dried to provide a powder form of the cocoa husk extract.

The weight ratio of GABA to methylxanthines in the cocoa husk extract produced by this process is at least 1:20, preferably at least 1:15. An elevated ratio of GABA to methylxanthines is desirable to prevent the stimulatory affects of the methylxanthines from counteracting the relaxing/calming effects of the GABA.

In a preferred embodiment the extract is dried (i.e. it contains less than 5% wt % water). The total amount of GABA in the dry cocoa husk extract is preferably at least 0.7 mg/g, more preferably at least 0.8 mg/g, more preferably still at least 0.9 mg/g. Preferably the dry cocoa husk extract contains at most 20 mg/g methylxanthines, more preferably at most 15 mg/g, more preferably still at most 12.5 mg/g.

The cocoa husk extract provides a natural, clean-label and consumer-acceptable source of GABA. The cocoa husk extract can be combined with other ingredients to form a food product which provides relaxing/calming effects due to the elevated levels of GABA whilst utilizing entirely natural ingredients. Such a product will preferably comprise at least 0.001 mg/g GABA, more preferably at least 0.005 mg/g, more preferably still at least 0.0075 mg/g. Preferably the product comprises at most 0.2 mg/g methylxanthines, more preferably at most 0.15 mg/g.

In a preferred embodiment the product is a frozen confection product comprising a frozen composition (such as ice cream) and a chocolate composition or a chocolate analogue composition, wherein the frozen confection comprises at least 0.005 mg/g GABA and at most 0.075 mg/g methylxanthines. The term “chocolate” as used herein includes dark chocolate, white chocolate and milk chocolate. The term “chocolate composition” also includes cocoa-based products such as cocoa mass, cocoa powder etc. The term “chocolate analogue” means chocolate-like fat-based confectionery compositions made with fats other than cocoa butter (for example cocoa butter equivalents, coconut oil or other vegetable oils). Such chocolate analogues are sometimes known as “couvertures”. Chocolate and chocolate analogues may contain cocoa powder, milk solids, sugar or other sweeteners and flavourings. Preferably the frozen confection comprises at least 0.01 mg/g and at most 20 mg/g GABA, and preferably at most 0.015 mg/g methylxanthines. The chocolate composition or chocolate analogue composition may be in any suitable form, such as a coating on the frozen composition, as pieces (inclusions) located within the frozen composition, a sauce, e.g. as a ripple or swirl in the frozen composition or simply in the form of a flavouring mixed into the ice cream, e.g. cocoa powder.

The present invention will now be further described with reference to the following non-limiting examples.

### EXAMPLE 1

### Production of Cocoa Husk Extract

Cocoa husk extracts having elevated GABA levels were prepared as follows. Cocoa husk (horticultural grade) was obtained from a local garden centre. Approximately 1 kg of the cocoa husk was weighed onto a sheet of aluminium foil and dried in an oven at 100° C. for 30 mins. The dried cocoa husk was transferred into a container and allowed to cool to room temperature. 500 g of the dried cocoa husk was weighed into a large thick-walled transparent plastic bag. 1500 ml of ultra pure water was added and the bag was sealed, allowing approximately 500 ml of air to remain inside in order to facilitate mixing. The bag was agitated and massaged at approximately 5 minute intervals over an extraction period of 30 minutes. The cocoa husks and the liquid were then separated by pouring the liquid out of the bag and by pressing the remaining husks to remove further liquid, yielding approximately 800 ml in total. The level of GABA in the liquid was measured using LC-MS and was found to be 0.209 mg/g. The amounts of theobromine and caffeine were determined using HPLC and were found to be 3.77 mg/g and 0.70 mg/g respectively. The liquid was then poured into 60 ml centrifuge tubes and centrifuged in batches for 10 minutes at 4000 rpm to remove small particles of water-insoluble materials. The supernatants were then combined and mixed to ensure homogeneity.

In order to remove some of the methylxanthines (including caffeine and theobromine), solvent extraction was performed. 200 ml of supernatant was charged into a 500 ml separating funnel and approximately 50-100 ml of dichloromethane was added. The funnel was stoppered, shaken well for a few minutes and then inverted and vented via the tap to release pressure. This process was repeated several times, after which the separating funnel was placed in a clamp stand and left for several hours to allow separation to take place. Once the liquids had separated, the lower aqueous layer was run off into a clean container. The cloudy interface was further separated using a laboratory centrifuge (capable of 4000 rpm) and the aqueous supernatant layer was collected. This process was repeated a further two times. The solvent extraction process removed 99.9% of the caffeine and more than 30% of the theobromine from the crude cocoa husk extract as measured using HPLC.

The aqueous layer, which forms the aqueous cocoa husk extract, contains some soluble high molecular weight compounds such as fibres, cellulose & carbohydrates. These can be removed by molecular weight extraction. Molecular weight cut-off micro centrifuge filtration tubes (Whatman Vectaspin 3000 Daltons) were loaded with 0.5 ml of the extract. The tubes were high-speed centrifuged at 13500 rpm for 10 minutes to remove approximately 20% of the fibrous material.

The cocoa husk extract was then mixed to ensure homogeneity prior to freeze drying. Approximately 170 ml of the cocoa husk extract was placed in a 500 ml round bottom flask. A freezing mix of dry ice and acetone was prepared in a large evaporating dish. The base of the flask was placed into the freezing mix. As the mix started to freeze, the flask was rotated to maximise the area of the wall onto which the cocoa husk extract could freeze. This process was repeated using further flasks until all the cocoa husk extract had been frozen. The flasks were then placed in a vacuum freeze drier and dried for 24-48 hours, so that no ice was visible.

After freeze-drying, the cocoa husk extract was removed from the flasks by scraping with a spatula, placed in a glass beaker and dried for 2 hours in a vacuum oven at 45° C. and −1020 mbar. Finally, the dried cocoa husk extract was ground into a fine powder using a pestle and mortar.

The level of GABA in the dried cocoa husk extract was measured using LC-MS and was found to be 0.97 mg/g. The amounts of theobromine and caffeine were determined using HPLC and were found to be 10.1 mg/g and 0.86 mg/g respectively.

### EXAMPLE 2

### Chocolate Product Containing Cocoa Husk Extract

A chocolate milk drink was prepared using the dried cocoa husk extract from example 1. The drink was prepared by mixing 0.75 g of standard defatted cocoa powder (GABA content 0.20 mg/g) and 0.25 g of the dried cocoa husk extract (GABA content 0.97 mg/g) into 49 ml of semi-skimmed milk. A conventional product without the extract was prepared using 1 g of cocoa powder in 49 ml of semi-skimmed milk. The amounts of GABA in the products were 0.39 mg and 0.2 mg in 50 ml respectively. Thus the chocolate milk drink made using the cocoa husk extract had a GABA content of 0.0079 mg/ml which is approximately twice that of the GABA content of the conventional product (i.e. 0.0040 mg/ml).

### EXAMPLE 3

### Frozen Confection Product Containing Cocoa Husk Extract

A chocolate coated ice cream product comprising 69 g of ice cream coated with 24 g of chocolate may be made using the cocoa husk extract. Table 1 shows the compositions of the chocolate coatings of a standard chocolate coated ice cream product (Comparative example) and of a chocolate coated ice cream product comprising the dried cocoa husk extract from example 1 (Example 3).

TABLE 1
Table 1 - Formulation of chocolate coatings

| Ingredients (wt %) | Comparative example | Example 3 |
|---|---|---|
| Sucrose | 39.5 | 34.5 |
| Cocoa husk extract (dried) | — | 5 |
| Cocoa butter | 24.5 | 24.5 |
| Cocoa Mass (45% cocoa powder) | 21 | 21 |
| Whole milk powder | 9.5 | 9.5 |
| Butter oil | 5 | 5 |
| Lecithin | 0.4 | 0.4 |
| Vanillin | 0.05 | 0.05 |
| Polyglyceryl polyricinoleate | 0.05 | 0.05 |

The cocoa husk extract used in example 3 provides an additional 0.24 mg of GABA to the chocolate coating of the frozen confection product.

The various features and embodiments of the present invention, referred to in individual sections above apply, as appropriate, to other sections, mutatis mutandis. Consequently features specified in one section may be combined with features specified in other sections, as appropriate. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

1. A process for producing a cocoa husk extract containing gamma-aminobutyric acid (GABA), the process comprising:
a) Extracting GABA and methylxanthines from cocoa husks with an aqueous medium thereby to form an aqueous solution containing GABA and methylxanthines; then
b) Removing at least part of the methylxanthines from the aqueous solution with a solvent which is immiscible with water; and then
c) Retaining the aqueous solution containing the GABA.

2. A process according to claim 1 wherein the aqueous medium is an aqueous solution.

3. A process according to claim 2 wherein the aqueous solution is at a temperature of from 0 to 70° C.

4. A process according to claim 2 wherein the aqueous solution has a pH of from 5 to 9.

5. A process according to claim 1 wherein the cocoa husks are in contact with the aqueous medium for at least 10 seconds.

6. A process according to claim 1 wherein the husks are removed from the aqueous solution obtained in step a), either before or after step b).

7. A process according to claim 1 wherein the aqueous solution obtained in step a) is filtered and/or centrifuged either before or after step b).

8. A process according to claim 1 wherein molecules with a molecular weight greater than 150 g/mol are removed from the aqueous solution either before or after step b).

9. A process according to claim 1 wherein the aqueous solution containing the GABA is dried after step c).

10. A cocoa husk extract comprising GABA and methylxanthines wherein the ratio of GABA to methylxanthines is at least 1:20.

11. A cocoa husk extract according to claim 10 wherein the ratio of GABA to methylxanthines is at least 1:15.

12. A cocoa husk extract according to claim 10 wherein the cocoa husk extract contains less than 5 wt % water.

13. A cocoa husk extract according to claim 12 wherein the cocoa husk extract contains at least 0.7 mg/g GABA and at most 20 mg/g methylxanthines.

14. A food product containing an extract according to claim 10.

15. A product according to claim 14 which is a frozen confection comprising a frozen composition and a chocolate or chocolate analogue composition.
